(19) United States
(12) Patent Application Publication
(10) Pub. No.: US 2018/0082285 A1
(43) Pub. Date: Mar. 22, 2018

(54) TRANSACTION CARD SELECTION BASED ON GEOGRAPHIC AREA

(71) Applicant: Apple Inc., Cupertino, CA (US)

(72) Inventors: Alosious Pradeep Prabhakar, Singapore (SG); Alistair McFarlane, Uxbridge (GB); Mohammad Amin Malek, New South Wales (AU); Simon Tulloch, Sydney (AU)

(21) Appl. No.: 15/273,360

(22) Filed: Sep. 22, 2016

(51) Int. Cl. G06Q 20/36; G06Q 20/32; H04W 4/02; H04W 4/00; G06F 17/30; H04W 76/02

(52) U.S. Cl. CPC G06Q 20/3674; G06Q 20/3221; H04W 76/02; H04W 4/008; G06F 17/30864; H04W 4/021

(57) ABSTRACT

The disclosed technology addresses the need in the art for a mobile wallet application that can intelligently select a transaction based on a geographic region in which the card was issued, and in which a transaction is to take place. The present technology can determine a region where a transaction card was issued from, and designate the transaction card as the default card for the determined region, and can automatically select the card for use with transactions taking place in the determined region.

### TECHNICAL FIELD

The present technology pertains to automatic selection of a transaction card and more specifically pertains to making a transaction card a default transaction card for a geographic area when the transaction card was issued from a provider located within that geographic area.

### BACKGROUND

Mobile wallet applications have begun to gain popularity as more and more merchants now accept mobile device enabled transactions, such as utilizing near-field communications. However, this technology still remains in its infancy and presents many inconveniences to the user that need to be matured to aid further adoption of the technology. One such user inconvenience is for users with multiple cards. Users with multiple cards would benefit from better intelligence from mobile wallet applications in knowing which of the multiple cards to use for a specific transaction.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for configuring a transaction card, stored in a mobile wallet application, to be a default transaction card for transaction taking place in a geographic area. A mobile wallet application can learn from an operating system of a mobile device what geographic region the mobile device is within and automatically select the appropriate transaction card. In some embodiments, the mobile wallet application can automatically designate, or suggest for user confirmation, a transaction card to be the default transaction card for a geographic region according to where an issuer of a transaction card is located. For example, if mobile wallet application includes a first transaction card issued from a provider within the United States, and a second transaction card issued from a provider in Australia, the first transaction card can be designated as the default card for transactions in the United States, and the second transaction card can be designated as the default card for transactions in Australia.

In some embodiments the disclosed technology pertains to a non-transitory computer-readable medium storing computer executable instructions. The instructions are effective for causing the mobile device to add a second transaction card to a mobile wallet application by receiving information from a second service provider that issued the second transaction card including information that the second service provider is located within a second geographic region. In some embodiments, the second service provider is a third party to the mobile wallet application. The mobile wallet application is further caused to determine that the second geographic region is different than a first geographic region in which a first service provider is located, and to conduct a transaction utilizing the second transaction card. The mobile wallet application conducts transaction by determining that the mobile device is within the second geographic region, and automatically utilizing the second transaction card in a transaction when the location of the mobile device was determined to be the second geographic region.

In some embodiments the disclosed technology pertains to a method that includes receiving a request to add a second transaction card to a mobile wallet application. After receiving the request, the mobile wallet application communicates with a transaction network to learn a geographic region in which a second service provider, that issued the second transaction card, is located. The mobile wallet application additionally stores a first transaction card associated with a first geographic region, and the second transaction card which is associated the geographic region of the second service provider. The geographic region of the second service provider is different than the first geographic region. The method further includes initiating a transaction using the mobile device, using the mobile wallet to determine a geographic region in which the mobile device is located; and automatically select the second transaction card for use in the transaction when the mobile device is determined to be the second region.

In some embodiments the disclosed technology pertains a mobile computing device comprising a mobile wallet application configured to store and manage at least a first transaction card and a second transaction card, and to utilize one of the first transaction card or the second transaction card in connection with a service. The first transaction card was issued by a first issuer within a first geographic region, and the second transaction card was issued by a second issuer within a second geographic region. The second transaction card is appointed as the default card for transactions taking place within the second geographic region. The mobile device also includes one or more communication interfaces configured to communicate with the service and to communicate with a communications network. The mobile device also includes a network connection application configured to initiate a connection with the communications network utilizing the one or more communication interfaces, the network connection application configured to receive region identifying information from the communications network. The mobile wallet application of the mobile device is also configured to learn of a region of the mobile device from the network connection application and the region identifying information, and when the location of the mobile device is within the second geographic region, to select the second transaction card for use with the service.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example configuration of devices and a network;

FIG. 2 illustrates an example method for storing a transaction card in a mobile wallet application;

FIG. 3 illustrates an example method for automatically recommending a transaction card to be a default transaction card for a geographic region;

FIG. 4 illustrates an example user interface for recommending that a transaction card be a default transaction card for a geographic region;

FIG. 5A illustrates an example method of automatically selecting a transaction card to use in a transaction based on geographic region after a mobile wallet application has been affirmatively launched;

FIG. 5B illustrates an example method of automatically launching a mobile wallet application in a background process to select a transaction card in preparation for a future transaction based on geographic region;

FIG. 6 illustrates a graphical user interface of a transaction card having been automatically selected based on geographic region; and

FIG. 7 illustrates an example system configuration.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for a mobile wallet application that can intelligently select a transaction based on a geographic region in which the card was issued, and in which a transaction is to take place. For example, a past mobile wallet application might have two transaction cards such as credit cards, where one transaction card is issued by a bank in the United States, while the other transaction card is issued by a bank in Australia. Past mobile wallets might utilize one card as the default transaction card regardless of the country in which the transaction is taking place. Accordingly, if the default transaction card is the card issued by a bank in the United States, but the transaction is to take place in Australia, a user must manually switch cards to avoid using the card issued in the United States for an Australian transaction. Of course if the card from the United States were to be used, an international transaction fee might apply. The present technology solves this problem by first determining a country in which a transaction is to take place before the mobile wallet automatically selects a card to use in the transaction.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software.

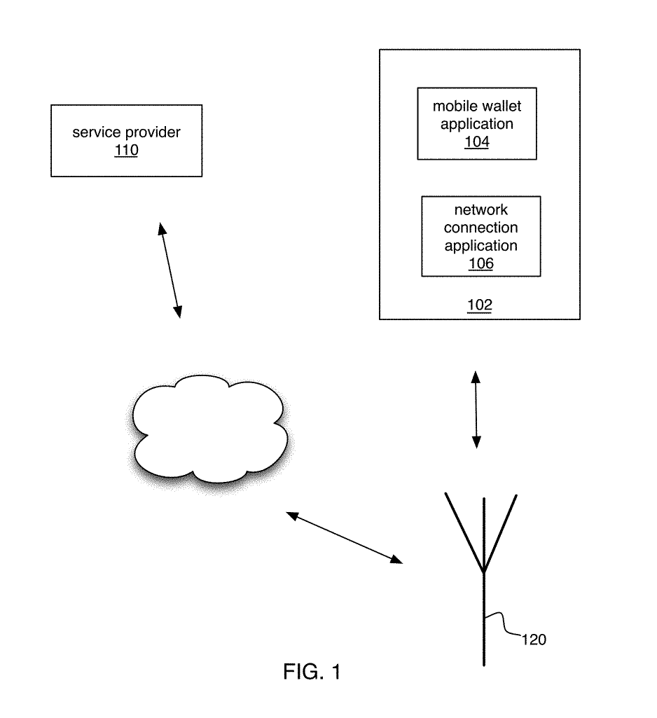

FIG. 1 illustrates an example configuration of devices and a network used with the present technology. FIG. 1 will be referred to in more detail in the context of the other figures and description herein. However a brief description of FIG. 1 follows. As addressed above, the present technology involves a mobile wallet application 104 resident on a mobile device 102. The mobile wallet application 104 is configured to store, manage, and utilize transaction cards. The mobile device 102 can learn of its own location through a network connection application 106.

The network connection application 106 can be an operating system level application responsible for making a connection to a communications network. For example the network connection application 106 can be a telephony application that can communicate with a telecommunications network to gain access to the telecommunications network such as a mobile communication network for carrying voice or data transmissions. The telecommunications network access point, (e.g, a cell phone tower) is represented in this instance by antennae 120. When connected to a mobile telecommunications network, the network connection application can learn of a geographic area code, such as a mobile country code associated with the telecommunications network. The network connection application 106 can also be an application for accessing a Wi-Fi network and maintaining an issued IP address of the mobile device 102 as well as learning of the IP address of a Wi-Fi gateway which is represented in this instance by antennae 120. When connected to a Wi-Fi network, network connection manager application 106 can use the IP address of the Wi-Fi gateway to look up, in a geo-location lookup database, a geographic region for a network having that IP address to learn which geographic region the mobile device 102 is located within. Antennae 120 can represent any access point for any type of communication network.

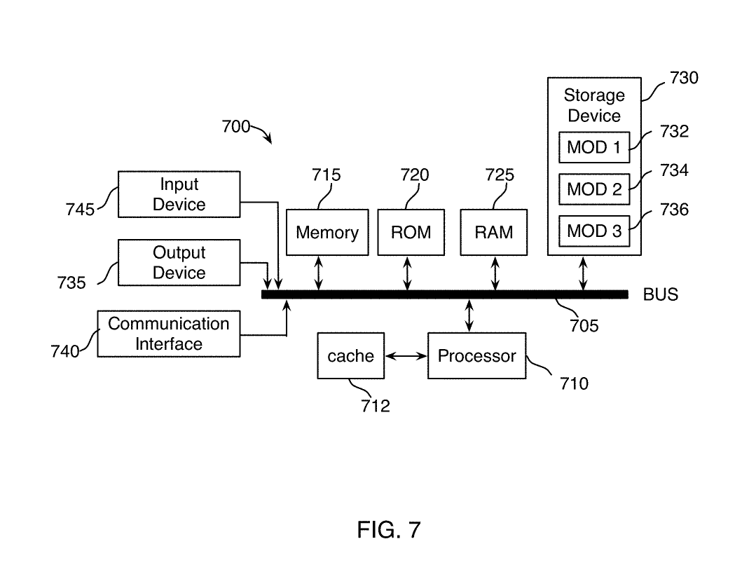

In addition to communicating with a network to learn which geographic region mobile device 102 is located, mobile device 102 can communicate using one or more communication interfaces (not shown, but described with reference to FIG. 7, 740) to communicate through a communication network (telecommunications network, Wi-Fi network, or other access network). In some embodiments, the mobile wallet application communicates over the Internet with a service provider 110 to learn details about a transaction card. In one example the service provider 110 is a transaction card issuer. In some embodiments, the mobile wallet application 104 might not communicate directly with service provider 104, and instead may communicate with transaction network that mediates transactions with service provider 110. An example of a transaction network might be the VISA network, while the service provider 110 is the underlying bank that issued a VISA branded credit card.

Transaction cards can be cards that facilitate, or are required for, a transaction. In some embodiments transaction cards include financial transaction cards, such as credit, debit, charge, and ATM cards, etc. However, transaction cards could also include access cards such as those utilized to gain access to a building, device, service, event, etc. Transaction cards can also include identification cards. As described herein aspects of the present technology involve selecting from among two or more transaction cards usable for the same function or service (i.e., two or more financial transaction cards, or two or more access cards) based on an associated geographic region.

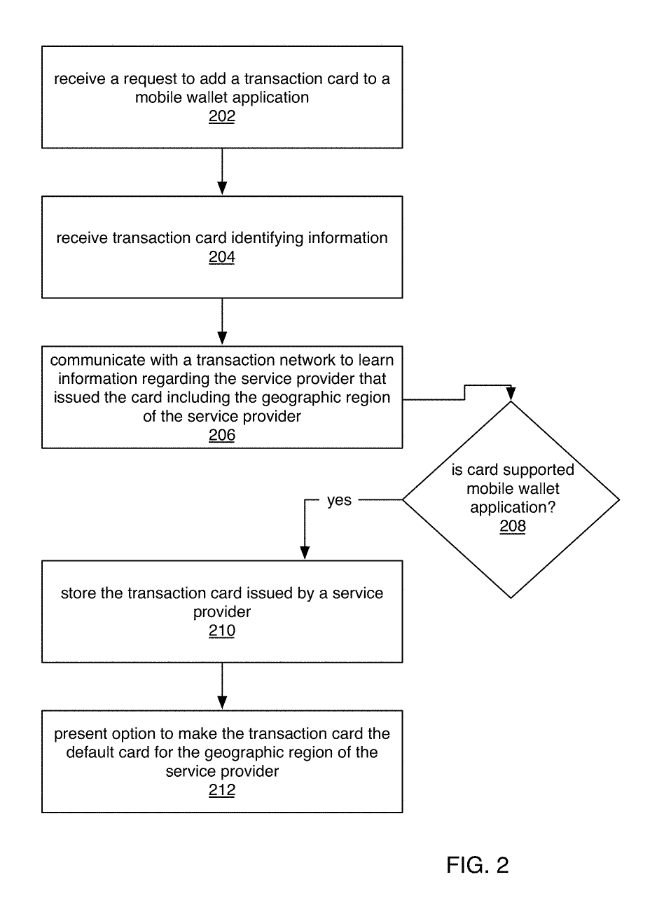

FIG. 2 illustrates an example method for storing a transaction card in a mobile wallet application. The method begins when the mobile wallet application 104 receives a request 202 to add a transaction card to the mobile wallet application 104. The request can be made by a user interacting with a user interface (such as input device 745) of the mobile device 102.

The mobile wallet application receives 204 transaction card identifying information in a variety of ways. In some embodiments, such as with transaction cards that have card identifying information printed on the card, the card identifying information can be entered by a user through a user interface of the mobile device 102. In some embodiments, a camera of the mobile device 102 can be utilized to capture an image of the transaction card and the card identifying information. Such an image can be processed by the mobile device to extract the card identifying information from the image of the transaction card. In some embodiments, such as with transaction cards that have card identifying information electronically stored, the card identifying data can be electronically read or interrogated by the mobile device 102 with or without additional hardware as necessary. For example, if the transaction card is an NFC enabled card, the mobile device 102 can utilize a NFC card reader/transmitter built into the mobile device to read the transaction card. However, if the transaction card includes a magnetic stripe or IC chip, a card reader configured to read the card might be required.

After the mobile wallet application has received the card identifying information 204, it can be beneficial to communicate 206 with a transaction network to learn information regarding the service provider that issued the card including the geographic region of the service provider. In embodiments wherein the transaction card is a financial transaction card, the mobile wallet application 104 can communicate with a payment network (e.g., Visa, MasterCard, American Express, Discover, etc.) to learn further details about the financial transaction card, including the issuing bank (e.g. CitiBank, Capital One, Chase, etc.) and an address of the issuing bank.

In some embodiments, such as with respect to the payment networks named above, the transaction network is provided by a third party. The service provider that issues the card can also be a third party. By third party it is meant an entity that offers a service that is useful to the mobile wallet, but that is not under the control of the mobile wallet, or providers of the mobile wallet.

In embodiments where the transaction card is an access card, the transaction network and the service provider could be the same entity. For example, some access cards do not require a transaction to take place over the Internet, but rather are handled via a local network transaction. In such embodiments, step 206 can involve attempting to use the card for access to the building, service, etc., and the geographic location of the access point can be recorded as the geographic region of the service provider.

Even in transactions over the Internet, in some embodiments, the transaction network can be the same as the service provider.

In some embodiments, it can be possible to learn the region of the card issuer directly from the transaction card.

Communication (206) can also be useful for other purposes beyond learning the region of a card provider. In some embodiments, communication with the transaction network 206 can be used to determine if the transaction card is valid.

In some embodiments, the mobile wallet application might not support all transaction cards 208. For example, the mobile payment service APPLE PAY that is used in conjunction with the mobile wallet application APPLE WALLET does not support all financial transaction cards. APPLE PAY requires a card issuing bank to enroll in APPLE PAY since APPLE PAY utilizes one time use financial transaction card numbers that need to be configured between the card issuing bank and APPLE WALLET. Thus, in some embodiments, after learning of the card issuing bank from communication 206, the mobile wallet application 104 determines if the card is supported by the mobile wallet application 208?

If the answer to query 208 is “yes,” the mobile wallet application 104 stores the transaction card 210. If the answer to query 208 is “no,” the card might not be stored in the mobile wallet, or it might be stored, but not eligible for use with some features supported by the mobile wallet such as APPLE PAY.

Since mobile wallet application 104 learned of a region of a card issuer at step 206, the mobile wallet 104 can present an option to make the transaction card the default card for the geographic region of the service provider 212. In some embodiments step 212 might not be performed until a second transaction card is added, or until the card is utilized in a transaction.

Step 212 can be associated with rules or heuristics for suggesting that a card be a default card for a particular geographic region. In embodiments wherein the transaction card is a financial transaction card, the default geographic region for the card can be the geographic region that includes the issuing bank since often transaction fees can occur outside of a home geographic region. In embodiments wherein the transaction card is an access card to a physical structure, the geographic region could be the region in which the physical structure exists.

The definition of a geographic region can vary according to transaction card type too. In the case of a financial transaction card the geographic region would generally be a country (or region with shared currency) in which the issuing bank is located. In the case of an access card, the geographic region can be a radius around the physical structure(s) or campus for which the access card provides access.

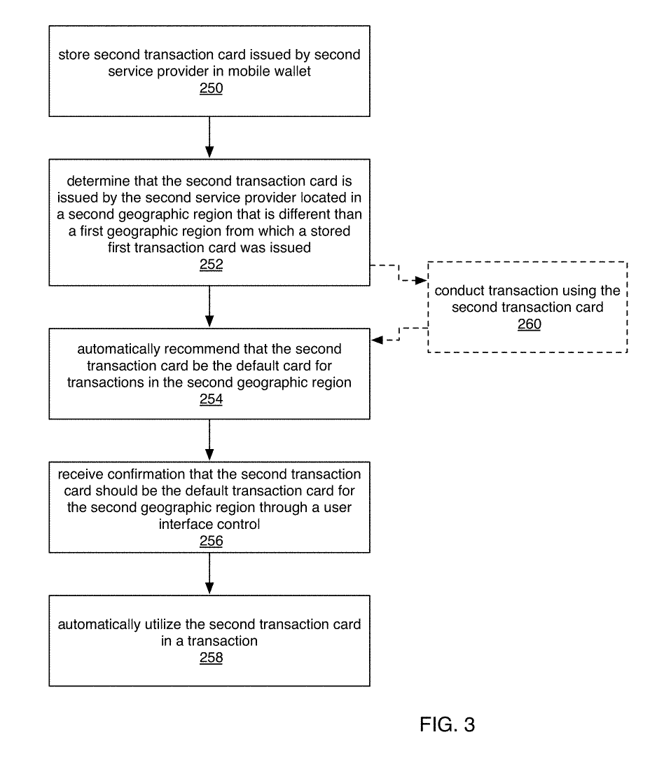

FIG. 3 illustrates an example method for automatically recommending a transaction card to be a default transaction card for a geographic region. In some embodiments, mobile wallet application can have two or more transaction cards for the same purpose and it can be desirable to recommend one of the two or more transaction cards based on a geographic region.

The method illustrated in FIG. 3 begins with mobile wallet application 104 storing 250 a second transaction card issued by a second service provider. The storing 250 of the second transaction card can be handled in the same manner as described with respect to FIG. 2.

After storing the second transaction card, mobile wallet application 104 can determine 252 that the second transaction card is issued by the second service provider that is located within a second geographic region that is different than the first geographic region from which the stored first transaction card was issued.

After determining that the second transaction card is issued by the second service provider that is located within a second geographic region that is different than the first geographic region from which the stored first transaction card was issued, mobile wallet application 104 can automatically recommend 254 that the second transaction card be the default card for transactions in the second geographic region.

In the context of financial transaction cards, the first financial transaction card could be issued from a bank in the United States, and the second financial transaction card could be issued from a bank in Australia. The method illustrated in FIG. 3 can be used to configure the first financial transaction card to be the default financial transaction card in the United States, and the second financial transaction card to be the default financial transaction card in Australia.

If the user of mobile device 102 wishes to accept the recommendation, the user can provide confirmation to the mobile wallet application 104 through a user interface of mobile device 102. Mobile wallet application 104 can receive 256 the provided confirmation that the second transaction card should be the default transaction card for the second geographic region, and thereafter automatically utilize 258 the second transaction card in transactions where mobile device 102 is within the second geographic region.

Optionally, in some embodiments, the mobile wallet application 104 can wait until after an initial transaction 260 is conducted using the second transaction card before automatically recommending 254 that the second transaction card be the default card.

As described above a transaction card would only be labeled as a default card for transactions to take place in the same geographic region as the card was issue from. However, it can be possible that a card might made a default transaction for all general transactions, expect those transactions for which another card is the default. For example, in the financial transaction card context it may be that mobile wallet application 104 has two financial transaction cards stored within it. A first financial transaction card issued from the United States, and a second financial transaction card issued from Australia. It can be desirable to have a default financial transaction card for transactions taking place outside the United States or Australia. In such an embodiment, one of the first financial transaction card or the second financial transaction card can be designated a general default transaction card so that it would also be the default financial transaction card for the rest of the world outside of the United States and Australia.

In some embodiments, the card that is added to the mobile wallet first is the general default financial transaction card. In some embodiments, the mobile wallet can monitor usage of the first financial transaction card and the second financial transaction card and select the most widely used as the general default financial transaction card. In some embodiments, the mobile wallet can select the financial transaction card that has the lowest international transaction fees or the lowest interest rates as the general default financial transaction card.

In some embodiments a financial transaction card that is issued from a “home” geographic region can be the general default financial transaction card. The “home” geographic region could be determined by matching a geographic region for one of the financial transaction cards with a geographic region identified as a home address in a user account of an unrelated service. For example, mobile wallet 104 could query another service such as a social media service or an online store like ITUNES to correlate a home geographic region. In some embodiments, a contact list of a mobile device might also be used to determine a home region when a user has their own address in their address book, or alternatively, the user's home region can be assumed to be a region which the mobile device is within most of the time as determined by a location service on the mobile device 102.

In some embodiments a transaction card can be made a default card for a geographic region by a user of the mobile wallet application by designating parameters for transaction card use in a settings or options menu.

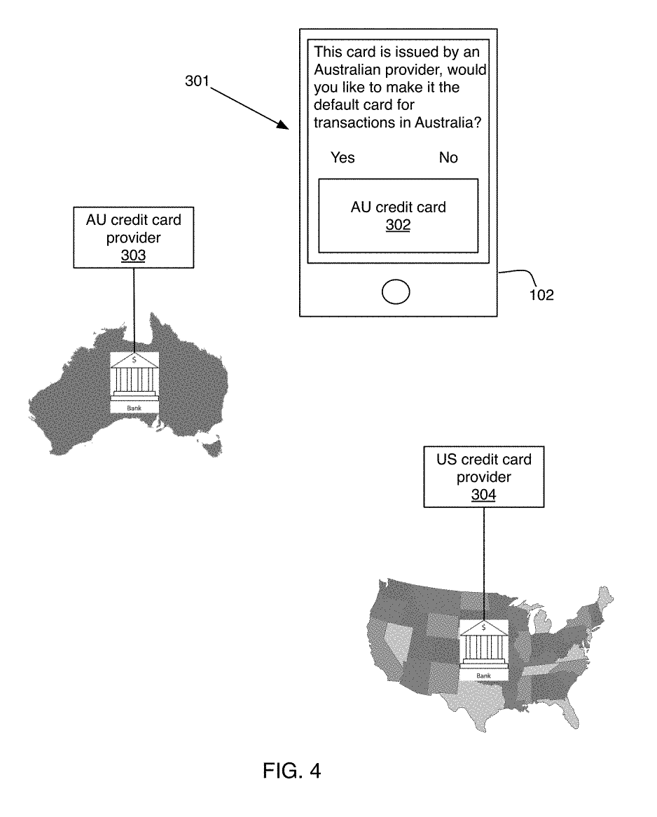

FIG. 4 illustrates an example user interface 301 on mobile device 102 for recommending that a transaction card be a default transaction card for a geographic region. User interface 301 can be displayed as the result of, for example, step 212 of FIG. 2 or step 254 of FIG. 3. Specifically, mobile wallet 104 recognizes that card 302, was issued by an Australian card provider 303 located in Australia. After learning or determining that card 302 was issued from an Australian card provider, mobile device 102 can issue a user interface 301 suggesting or recommending that the card 302 be made the default transaction card for transactions in Australia, and present a user interface control effective to receive a user input accepting the Australian issued card 302 as the default card for transactions in Australia, or rejecting the choice to make card 302 the default card for transactions in Australia. FIG. 4 also illustrates a US credit card provider 304 for the purposes of illustrating that the transaction cards can be issued by providers in different geographic regions, however, the mobile wallet 104 on device may or may not include a transaction card issued from US credit card provider 304.

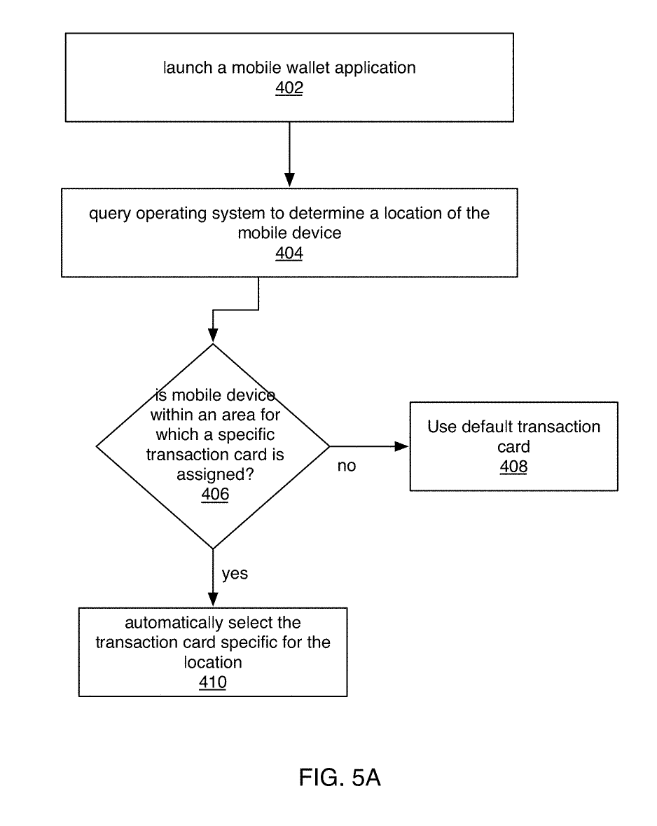

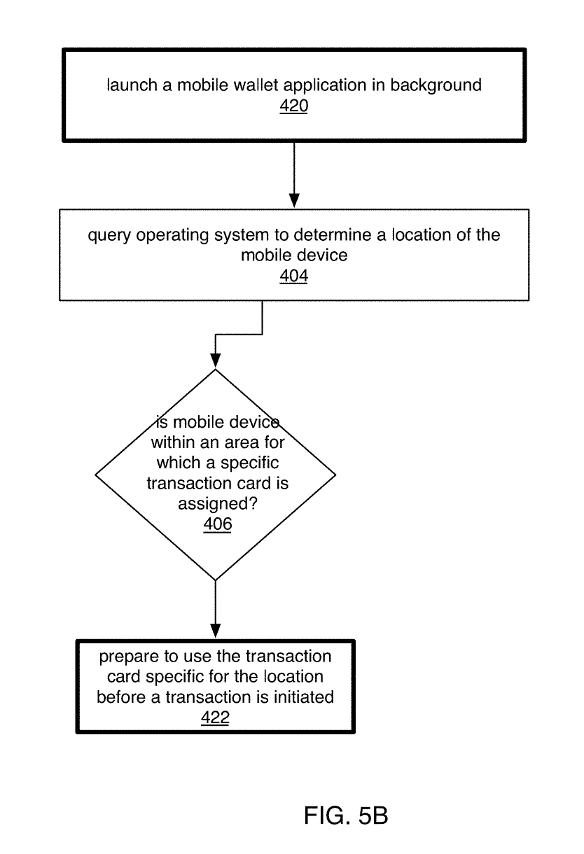

FIG. 5A illustrates an example method of automatically selecting a transaction card to use in a transaction based on geographic region after a mobile wallet application has been affirmatively launched. In this example a user of mobile device 102 desires to utilize a transaction card and launches mobile wallet application 402. The mobile wallet application queries the operating system of mobile device 102 to determine a location of the mobile device 404.

The operating system can learn of the location of a mobile device through one or more network connections, and which method of learning a location is sufficient can depend on the size of a geographic area associated with a transaction card or other details of a given use case. In some embodiments, such as in embodiments dealing with financial transaction cards, the geographic region can be a country. In such cases, mobile wallet application 104 can learn of the location of the mobile device 102 through a telephony application, or other application that communicates with a mobile telecommunications network. Mobile telecommunications networks commonly transmit a mobile country code as part of a connection handshake with the mobile telecommunications network. In some embodiments, such as when the transaction card is an access card, the geographic region might be big enough to encompass a region around the access points of the building. In such embodiments, the mobile wallet application can communicate with Wi-Fi or Bluetooth handling applications to learn of the device's location. The mobile device can learn of the IP address of a Wi-Fi, or Bluetooth hotspot and perform a reverse lookup to determine whether the device is within the geographic regions associated with the transaction card. In some embodiment, utilizing Wi-Fi, or Bluetooth can be a preferred mechanism for learning a device's location even when accuracy is not required. For example, if a mobile device is roaming outside its home country, it might have its ability to connect to a mobile telecommunications network disabled, or its cellular interface disabled, and thus Wi-Fi is an alternative, or is Wi-Fi is also not enabled or available a Global Positioning System (GPS) can be used. In some embodiments, the mobile wallet 402 can also learn of the location of the mobile device through interrogating a card reader used to read the transaction card. In some embodiments GPS can also be used.

If the mobile wallet application 104 determines 406 that the mobile device is within an area for which a transaction card is assigned, the mobile wallet can automatically select the transaction card 410 that is default for the geographic area. If mobile wallet application 104 determines 406 that the mobile device 102 is not within an area for which a specific transaction card is assigned, mobile wallet application 104 can select and use a general default transaction card 408.

FIG. 5B illustrates an example method of automatically launching a mobile wallet application in a background process to select a transaction card in preparation for a future transaction based on geographic region. In some embodiments it can improve performance of the mobile wallet application if the default transaction card for a geographic region is known prior to a user launching mobile wallet application 104. In such embodiments, the mobile wallet application 104 can be configured to automatically launch as a background process 420 without its UI being rendered so that a user of the mobile device is unaware of its operation, and query the operating system 404 to determine a location of mobile device 102. This can be performed in a similar manner to that described with respect to FIG. 5A.

In some embodiments, mobile wallet application 104 can be launched whenever the device makes a new network connection, or gets turned on, or it can launch periodically.

In some embodiments, instead of launching 420 mobile wallet application 104 in the background to query 404 for the location of mobile device 102, another location aware process on mobile device 102 can monitor movements of mobile device 102 and notify mobile wallet application 104 to cause it to launch only when the mobile device has entered a perimeter around a location known to mobile wallet application 420. Or the location aware process can notify the mobile device 104 of all major movements of mobile device 102.

Once mobile wallet application 104 has learned of the location of the mobile device, mobile wallet application 104 determines whether mobile device 102 is within a geographic area for which a specific transaction card is configured as the default card 406. If a transaction card is a default card for the location of the mobile device 102, mobile wallet application prepares 422 to use the transaction card configured for the location of the mobile device prior to a transaction being initiated, or the mobile wallet application being launched by a user of mobile device 102.

Preparing to use a transaction card can include designating the transaction card that is default for the current region as the first card with which to attempt a transaction. For example, assume card one, is a transaction card issued from the United States and is the default financial transaction card for every country in the world, except Australia, for which card two, which is issued from an Australian bank, is the default. Without the method of FIG. 5B, a user might put mobile device 102 near an NFC card reader which will launch mobile wallet 104 and attempt a transaction. This complete process might only take one second. If mobile wallet 104 did not yet know mobile device 102 was located in Australia, it might first begin a transaction with card one, issued from the United States, and then need to discontinue a transaction, or ask a user for verification, in order to have the time to select the correct transaction card. However, with the method in FIG. 5B, card two, issued from the Australian bank would be the first card tried, and the transaction would provide a better user experience.

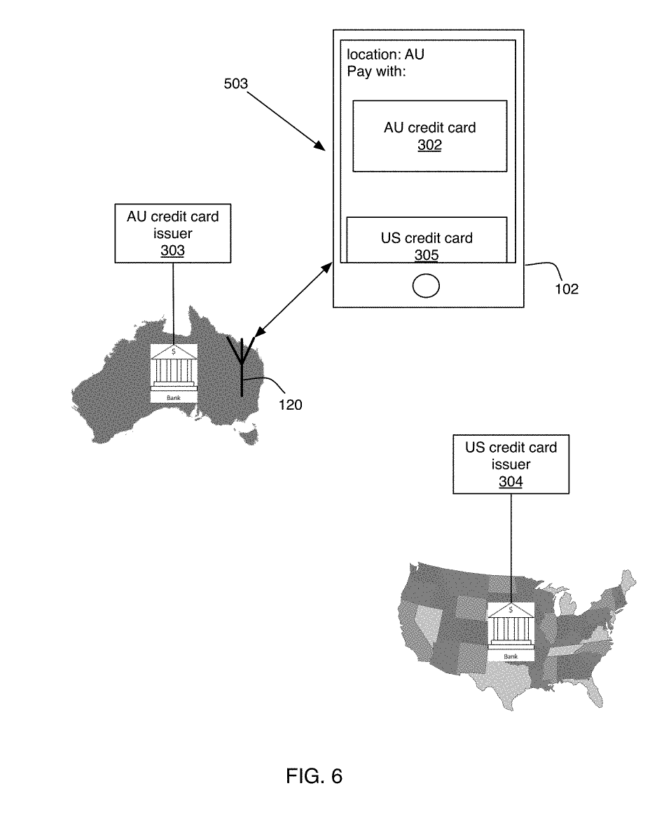

FIG. 6 illustrates a graphical user interface of a transaction card having been automatically selected based on geographic region. FIG. 6 illustrates mobile device 102 in communicating with an antenna of an access point (Wi-Fi, mobile telecommunications network, etc.) and thereby, mobile wallet 104 has learned that the mobile device is located within Australia. As such mobile wallet 104 can present an interface 503 showing that transaction card 304, issued from an Australian card provider 303, is the default card in this region. Graphical user interface 503 can also show other cards, or at least a portion thereof, such as a portion of card 305, issued from a card provider in the United States. In this case, a user of mobile wallet 104 can be aware of other choices that can be easily selected by tapping on any of the other choices such as card 305.

While the above description has only referred to transaction cards such as financial transaction cards or location access cards, this should not be considered limitation. Any access card for which it makes sense to have a geographic preference can be used with the present technology. Furthermore, the geographic area can include any geographic area including countries, provinces, states, territories, counties, towns, cities, geo-fences around an address or other location, etc.

While the above description has referred to establishing a default transaction card for a geographic area prior to a transaction, in some embodiments, a default transaction card can be configured during or after a use of a transaction card.

FIG. 7 illustrates a system bus computing system architecture 700 wherein the components of the system are in electrical communication with each other using a bus 705, however, other system architectures, such as chipset architectures are also possible. Example system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A non-transitory computer-readable medium storing computer executable instructions thereon, the instructions when executed by a mobile device effective for causing the mobile device to:
add a second transaction card to a mobile wallet application, wherein the instructions to add the second transaction card include instructions to:
receive information from a second service provider that issued the second transaction card including information that the second service provider is located within a second geographic region, wherein the second service provider is a third party;
determine that the second geographic region is different than a first geographic region in which a first service provider is located, the first service provider having issued a first transaction card that is stored in the mobile wallet application;
conduct a transaction utilizing the second transaction card, wherein the instructions to conduct the transaction include instructions to:
determine the mobile device is within the second geographic region; and
automatically utilize the second transaction card in a transaction when the mobile device was determined to be the second geographic region.

2. The non-transitory computer-readable medium of claim 1, wherein the instructions to determine that the mobile device is within the second geographic region includes instructions to cause the mobile device to:
detect a mobile country code associated with a telecommunications network; and
determine from the mobile country code that the mobile device is within the second geographic region.

3. The non-transitory computer-readable medium of claim 1, wherein the instructions to determine that the mobile device is within the second geographic region includes instructions to cause the mobile device to:
acquire an IP address of a Wi-Fi network, and
determine that the IP address is associated with a network with the second geographic region.

4. The non-transitory computer-readable medium of claim 1, wherein the instructions to add the second transaction card are effective to automatically recommend the second transaction card to be a default transaction card for transactions occurring within the second geographic region.

5. The non-transitory computer-readable medium of claim 1, wherein the instructions to conduct the transaction utilizing the second transaction card are effective to automatically recommend the second transaction card to be a default transaction card for transactions occurring within the second geographic region.

6. The non-transitory computer-readable medium of claim 1, wherein the instructions are effective to cause the mobile device to:
present a user interface control effective to receive a user input;
receive user input in the user interface control effective to make the second transaction card a default transaction card for transactions occurring within the second geographic region.

7. The non-transitory computer-readable medium of claim 1, wherein the instructions to add the second transaction card include instructions to confirm with the second service provider that the second transaction card is eligible for use with the mobile wallet application.

8. A method comprising:
receiving a request to add a second transaction card to a mobile wallet application;
after receiving the request, communicating with a transaction network to learn a geographic region in which a second service provider is located, the second service provider having issued the second transaction card;
storing in the mobile wallet application on a mobile device, a first transaction card associated with a first geographic region, and the second transaction card associated the geographic region of the second service provider, the geographic region of the second service provider being a second geographic region that is different than the first geographic region;
initiating a transaction using the mobile device;
determining a geographic region in which the mobile device is located; and
automatically selecting the second transaction card for use in the transaction when the mobile device is determined to be the second geographic region.

9. The method of claim 8, wherein the first geographic region is designated a home region when the first geographic region is the same geographic region as is associated with an account to which the mobile device is registered, and the second geographic region is outside the home region.

10. The method of claim 9, wherein the first transaction card associated with the designated home region is a default transaction card for all regions in the world except the second geographic region.

11. The method of claim 8, wherein the determining a geographic region in which the mobile device is located includes detecting a mobile country code associated with a telecommunications network, and determining if the mobile country code is the country code of the second geographic region.

12. The method of claim 8, wherein the determining the geographic region in which the mobile device is located includes:
acquiring an IP address of a Wi-Fi network, and
looking up the IP address in a database that resolves geographic locations based on IP addresses.

13. The method of claim 8, wherein the determining the geographic region in which the mobile device is located utilizing a global positioning system.

14. The method of claim 11, wherein detecting the mobile country code associated with the telecommunications network includes querying a mobile network connection application of the mobile device, wherein the mobile network connection application communicates with a mobile telecommunicates network to establish a connection between the mobile device and the mobile telecommunications network.

15. A mobile computing device comprising:
a mobile wallet application configured to store and manage at least a first transaction card and a second transaction card, and to utilize one of the first transaction card or the second transaction card in connection with a service, the first transaction card issued by a first service provider within a first geographic region, and the second transaction card issued by a second service provider within a second geographic region and being appointed as a default card for transactions taking place within the second geographic region;
one or more communication interfaces configured to communicate with the service and to communicate with a communications network; and
a network connection application configured to initiate a connection with the communications network utilizing the one or more communication interfaces, the network connection application configured to receive region identifying information from the communications network,
the mobile wallet application configured to learn of a region of the mobile computing device from the network connection application and the region identifying information, and when a location of the mobile device is within the second geographic region, to select the second transaction card for use with the service.

16. The mobile computing device of claim 15, wherein the mobile wallet application is configured to add the second transaction card, wherein the mobile wallet application is configured to:
communicate with a second service provider using the one or more communication interfaces to confirm that the second transaction card is eligible for use with the mobile wallet application, and
receive over the one or more communication interfaces information from the second service provider that issued the second transaction card including information that the second service provider is located within the second geographic region, wherein the second service provider is a third party;
determine that the second geographic region is different than the first geographic region in which the first service provider is located.

17. The mobile computing device of claim 15, wherein the mobile wallet application is configured automatically recommend the second transaction card to be a default transaction card for transactions occurring within the second geographic region.

18. The mobile computing device of claim 15, wherein the network connection application is a telephony application configured to communicate with a mobile telecommunications network.

19. The mobile computing device of claim 15, wherein the network connection application is a Wi-Fi connection manager configured to communicate with a wireless access point.

20. The mobile computing device of claim 15, wherein the network connection application is a Bluetooth connection manager configured to communicate with a Bluetooth access point.
